(19) United States
(12) Patent Application Publication
(10) Pub. No.: US 2026/0011071 A1
(43) Pub. Date: Jan. 8, 2026

(54) METHOD FOR INFORMATION PROCESSING, APPARATUS, DEVICE, COMPUTER-READABLE STORAGE MEDIUM, AND COMPUTER PROGRAM PRODUCT

(71) Applicant: Beijing Co Wheels Technology Co., Ltd., Beijing (CN)

(72) Inventors: Jiang GUO, Beijing (CN); Zongbao FENG, Beijing (CN); Zhenglong GUO, Beijing (CN); Jianbin ZHOU, Beijing (CN); Yiming ZHAO, Beijing (CN); Siyuan XU, Beijing (CN); Fu LIU, Beijing (CN); Haiyang SUN, Beijing (CN); Kun ZHAN, Beijing (CN); Chen LIU, Beijing (CN); Cheng BI, Beijing (CN); Qingtian NING, Beijing (CN); Yida WANG, Beijing (CN); Na LI, Beijing (CN)

(73) Assignee: Beijing Co Wheels Technology Co., Ltd., Beijing (CN)

(21) Appl. No.: 19/017,367

(22) Filed: Jan. 10, 2025

(30) Foreign Application Priority Data
Jul. 4, 2024 (CN) 202410898331.5

(51) Int. Cl. G06T 15/40; G06T 7/11; G06T 7/194; G06T 7/73; G06T 19/00; G06V 10/26; G06V 10/764; G06V 20/58; G06V 20/70

(52) U.S. Cl. CPC G06T 15/40; G06T 7/11; G06T 7/194; G06T 7/75; G06T 19/00; G06V 10/273; G06V 10/764; G06V 20/58; G06V 20/70; G06T 2207/10028; G06T 2207/30261; G06T 2210/56

(57) ABSTRACT

The present application provides a method for information processing, an apparatus, a device, a computer-readable storage medium, and a computer program product. The method includes that: initial scene information of a to-be-tested road section is acquired, where the initial scene information includes a scene image or a point cloud of a scene; and target scene information of a target vehicle traveling on the to-be-tested road section is generated according to the initial scene information by using a world model.

### CROSS-REFERENCE TO RELATED APPLICATION

The present application claims priority to Chinese Patent Application No. 202410898331.5 filed on Jul. 4, 2024, the disclosure of which is hereby incorporated by reference in its entirety.

### BACKGROUND

At present, scene simulation is beginning to be applied in more and more places, such as the scene of testing intelligent driving functions. Conventional intelligent driving function tests mostly relies on vehicles driving on actual roads, which requires a lot of manpower and material resources to support, and also demands a high level of skill from test drivers. Therefore, it is a new choice to use scene simulation to complete the test of intelligent driving functions. However, there are various problems in the existing scene simulation, which lead to the insufficient realism of the generated scene and cannot meet the actual needs. Therefore, how to generate scenes with high enough realism has become an urgent problem to be solved.

### SUMMARY

The present disclosure relates to an automatic driving test technology, and more particularly, to a method for information processing, an apparatus, a device, a computer-readable storage medium, and a computer program product. Embodiments of the present disclosure provide a method for information processing, an apparatus, a device, a computer-readable storage medium, and a computer program product.

The technical solution of the embodiments of the present disclosure is realized as follows.

An embodiment of the present disclosure provides a method for information processing. The method includes operations as follows.

Initial scene information of a to-be-tested road section is acquired, where the initial scene information includes a scene image or a point cloud of a scene.

Target scene information of a target vehicle traveling on the to-be-tested road section is generated according to the initial scene information by using a world model.

An embodiment of the present disclosure further provides a device for information processing, which includes a memory and a processor.

The memory is configured to store computer-executable instructions.

The processor is configured to execute the computer-executable instructions stored in the memory to perform operations of: acquiring initial scene information of a to-be-tested road section, wherein the initial scene information comprises a scene image or a point cloud of a scene; and generating target scene information of a target vehicle traveling on the to-be-tested road section according to the initial scene information by using a world model.

An embodiment of the present disclosure provides a non-transitory computer-readable storage medium having stored thereon computer-executable instructions that, when executed by a processor, perform operations of: acquiring initial scene information of a to-be-tested road section, wherein the initial scene information comprises a scene image or a point cloud of a scene; and generating target scene information of a target vehicle traveling on the to-be-tested road section according to the initial scene information by using a world model.

### BRIEF DESCRIPTION OF THE DRAWINGS

FIG. 1 is a first flowchart of a method for information processing according to an embodiment of the present disclosure.

FIG. 2 is a schematic diagram of an exemplary model training process according to an embodiment of the present disclosure.

FIG. 3 is a schematic diagram of an exemplary overall technical architecture according to an embodiment of the present disclosure.

FIG. 4 is a schematic diagram of an exemplary method for information processing according to an embodiment of the present disclosure.

FIG. 5 is a schematic diagram of a composition structure of an apparatus for information processing according to an embodiment of the present disclosure.

FIG. 6 is a schematic diagram of a composition structure of a device for information processing according to an embodiment of the present disclosure.

It should be pointed out that the above-mentioned “first” and “second” are only used to distinguish different solutions, and do not mean that they are used to distinguish the advantages and disadvantages of solutions or the priority in the implementation process.

### DETAILED DESCRIPTION

In order to make the purpose, technical solution and advantages of the present disclosure more clear, the present disclosure will be further described in detail below in combination with the accompanying figures. The described embodiments should not be regarded as limitation on the present disclosure. All other embodiments obtained by a person of ordinary skill in the art based on the embodiments of the present disclosure without paying inventive efforts shall fall within the scope of protection of the present disclosure.

In the following description, reference is made to “some embodiments” that describe a subset of all possible embodiments, but it is understood that “some embodiments” may be the same subset or different subsets of all possible embodiments and may be combined with each other without conflict.

In the following description, reference to the term “first\second\third” is merely to distinguish similar objects and does not represent a particular ordering of objects, and it should be understood that the “first\second third” may be interchanged in a particular order or priority order where permissible to enable the embodiments of the present disclosure described herein to be implemented in an order other than that illustrated or described herein.

In the embodiments of the present disclosure, the term “module” or “unit” refers to a computer program or a part of a computer program having a predetermined function and operating together with other relevant parts to achieve a predetermined object, and may be achieved in whole or in part by using software, hardware (such as an processing circuit or a memory), or a combination thereof. Likewise, a processor (or processors or memories) may be used to implement one or more modules or units. Furthermore, each module or unit may be part of an overall module or unit that contains the functions of the module or unit.

Unless otherwise defined, all technical and scientific terms used in the embodiments of the present disclosure have the same meanings as are commonly understood by those skilled in the art. The terms used in the embodiments of the present disclosure are for the purpose of describing embodiments of the present disclosure only and are not intended to limit the present disclosure.

In the embodiments of the present disclosure, the collection and processing of relevant data should be strictly carried out in accordance with the requirements of relevant national laws and regulations, the informed consent or individual consent of the personal information subject should be obtained, and subsequent data usage and processing should be carried out within the scope of laws and regulations as well as the authorization of the personal information subject.

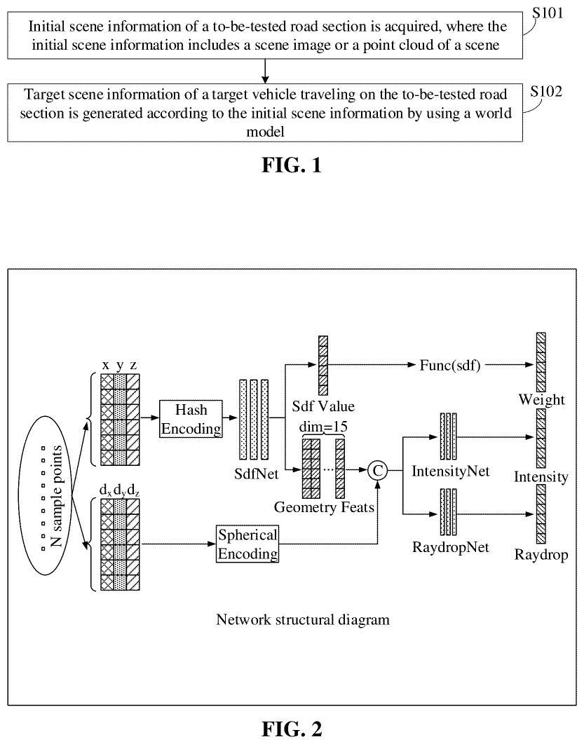

An embodiment of the present disclosure provides a method for information processing, which is applied to an apparatus for information processing. FIG. 1 is a first flowchart of a method for information processing according to the embodiment of the present disclosure. As illustrated in FIG. 1, the method for information processing, applied to the apparatus for information processing, may include operations as follows.

At S101, initial scene information of a to-be-tested road section is acquired.

The method for information processing according to the embodiment of the present disclosure is applicable to a scene in which target scene information is generated based on initial scene information.

In the embodiment of the present disclosure, the apparatus for information processing may be implemented in various forms. For example, the apparatus for information processing described in the present disclosure may include an apparatus such as a tablet, a notebook, a handheld computer, a Personal Digital Assistant (PDA), a Portable Media Player (PMP), a navigation device, a desktop computer, a server, and the like, and the specific apparatus for information processing may be determined according to the actual situation, and the embodiment of the present disclosure is not limited thereto.

It should be noted that the initial scene information includes a scene image or a point cloud of a scene. That is, the scene image may be used to describe the initial scene information, or the point cloud of the scene may be used to describe the initial scene information. Specifically, the expression manner of the initial scene information may be determined according to the actual situation, and the embodiment of the present disclosure is not limited thereto.

In the embodiment of the present disclosure, the initial scene information may be different types of objects present at the target vehicle position on the to-be-tested road section, as well as shapes, positions, movement speeds, and types of these objects, and other information.

It should be noted that the objects include a foreground object and a background object. The foreground object includes a person, a bicycle, an automobile, a dog, and the like, and the background object is an object that cannot be moved on a to-be-tested road section, such as a building, a telephone pole, and the like.

It should also be noted that the background object cannot move, that is, the movement speed of the background object may be 0.

In the embodiment of the present disclosure, the automatic driving model is provided in the target vehicle, and the to-be-tested road section may be a road section where the automatic driving model is tested for the target vehicle.

In the embodiment of the present disclosure, the apparatus for information processing may acquire the initial scene information from the target vehicle, may acquire the initial scene information from other devices (for example, the initial scene information from a sensor arranged in the target vehicle and for acquiring the scene information), may acquire the initial scene information after processing the information acquired from the sensor in the target vehicle, or may acquire the initial scene information by other manners, and the specific manner of acquiring the initial scene information by the apparatus for information processing may be determined according to the actual situation, and the embodiment of the present disclosure is not limited thereto.

In the embodiment of the present disclosure, the process of the apparatus for information processing acquiring the initial scene information of the to-be-tested road section includes that: first scene information of the target vehicle is acquired; and obstacle information is added to the first scene information to acquire the initial scene information.

It should be noted that the first scene information also includes a scene image or a point cloud of a scene. That is, the scene image may be used to describe the first scene information, or the point cloud of the scene may be used to describe the first scene information. Specifically, the expression manner of the first scene information may be determined according to the actual situation, and the embodiment of the present disclosure is not limited thereto.

In the embodiment of the present disclosure, the apparatus for information processing may first acquire the first scene information from the target vehicle, and then modify the object in the first scene information (such as adding obstacle information to the first scene information), thereby acquiring the initial scene information.

It should be noted that the first scene information may be information acquired from the target vehicle, information acquired from a scene acquisition sensor in the target vehicle, or information acquired by other manners by the apparatus for information processing, and the specific manner of acquiring the first scene information by the apparatus for information processing may be determined according to the actual situation, and the embodiment of the present disclosure is not limited thereto.

In the embodiment of the present disclosure, the obstacle information is object information that hinders the traveling of the target vehicle on the to-be-tested road section, such as a pedestrian, a bicycle, a large stone, and the like, and the specific obstacle information can be determined according to the actual situation, and the embodiment of the present disclosure is not limited thereto.

In the embodiment of the present disclosure, the apparatus for information processing may delete some obstacles in the first scene information to acquire initial scene information. The apparatus for information processing may replace some obstacles in the first scene information with obstacles that do not exist in the first scene information, thereby acquiring initial scene information. The specific manner of acquiring the initial scene information by the apparatus for information processing based on the first scene information can be determined according to the actual situation, and the embodiment of the present disclosure is not limited thereto.

In the embodiment of the present disclosure, the first scene information is information acquired by the target vehicle performing detection; or the first scene information is information generated by using a scene generation algorithm.

In the embodiment of the present disclosure, the specific manner of acquiring the first scene information by the apparatus for information processing may be determined according to the actual situation, and the embodiment of the present disclosure is not limited thereto.

It should be noted that the first scene information may be scene information collected by the target vehicle on the to-be-tested road section, scene information collected by other vehicles on the to-be-tested road section, or scene information collected by the target vehicle and other vehicles on the to-be-tested road section. Specifically, the first scene information may be determined according to the actual situation, and the embodiment of the present disclosure is not limited thereto.

In the embodiment of the present disclosure, if the first scene information is information acquired by the target vehicle performing detection, after determining the initial scene information according to the first scene information by using the apparatus for information processing, and generating the target scene information of the target vehicle traveling on the to-be-tested road section according to the initial scene information by using the world model, the target scene information is transmitted to the automatic driving model of the target vehicle to perform the automatic driving operation. Then, the next first scene information obtained by the target vehicle performing detection is acquired at the next moment; after determining the next initial scene information by the device for information processing according to the next first scene information, and generating the next target scene information of the target vehicle traveling on the to-be-tested road section according to the next initial scene information by using the world model, the next target scene information is transmitted to the automatic driving model of the target vehicle to perform the automatic driving operation; . . . ; cycle in turn until the automatic driving test task of the target vehicle on the to-be-tested road section is completed.

At S102, target scene information of a target vehicle traveling on the to-be-tested road section is generated according to the initial scene information by using a world model, so that the target scene information may be applied to an automatic driving model of the target vehicle.

In the embodiment of the present disclosure, after acquiring the initial scene information of the to-be-tested road section, the apparatus for information processing may generate target scene information of the target vehicle traveling on the to-be-tested road section based on the initial scene information by using the world model.

It should be noted that in the target scene information, a type of an object on the to-be-tested road section and motion information of the object are identified.

In the embodiment of the present disclosure, the world model may be a model configured in the apparatus for information processing, a model transmitted from other devices to the apparatus for information processing, or a model acquired by other manners by the apparatus for information processing. The specific manner of acquiring the world model by the apparatus for information processing may be determined according to the actual situation, and the embodiment of the present disclosure is not limited thereto.

In an embodiment of the present disclosure, the world model includes multiple models.

In the embodiment of the present disclosure, the process of the apparatus for information processing generating the target scene information of the target vehicle traveling on the to-be-tested road section according to the initial scene information by using the world model includes that: in a case that the initial scene information is the scene image, the initial scene information is input into the world model to acquire the target scene information.

It can be understood that the rendering speed of the world model is much higher than the rendering speed of the UE engine, so that the world model can be used to quickly determine the target scene information according to the initial scene information, and the efficiency of the closed-loop simulation is improved. The world model can render sensor data based on the pose information output by the automatic driving model, thereby completing the closed loop.

In the embodiment of the present disclosure, the process of the apparatus for information processing inputting the initial scene information into the world model to acquire the target scene information includes that: three-dimensional modeling is performed on the initial scene information by using the world model, to acquire foreground image information and background image information; the foreground image information is modified to acquire modified foreground image information; and the target scene information is determined according to the background image information and the modified foreground image information by using the world model.

In the embodiment of the present disclosure, through three-dimensional (3D) modeling, decoupling of the foreground and the background in the initial scene information may be realized, thereby acquiring the foreground image information and the background image information in the initial scene information.

In the embodiment of the present disclosure, the foreground object in the foreground image information may be modified by using the foreground object of the target vehicle on another road section or the foreground objects of other vehicles on other road sections, to acquire the modified foreground image information.

For example, if the foreground objects of other vehicles on other road sections include a large stone, the large stone may be added to the foreground image information to acquire the modified foreground image information; or a certain foreground object in the foreground image information is replaced with the large stone to acquire the modified foreground image information.

It should be noted that the specific manner of modifying the foreground image information to acquire the modified foreground image information can be determined according to the actual situation, and the embodiment of the present disclosure is not limited thereto.

It can be understood that the modified foreground image information is acquired by modifying the foreground image information, and a variety of data enhancement schemes are innovatively introduced to improve the generalization ability of the world model, so that the simulated sensor data is more realistic in the simulation environment, that is, the accuracy of generating the target scene information is improved, and the simulation accuracy is improved.

In an embodiment of the present disclosure, the world model includes a foreground field model and a background field model. The process of the apparatus for information processing generating the target scene information of the target vehicle traveling on the to-be-tested road section according to the initial scene information by using the world model includes that: in a case that the initial scene information is the point cloud, the initial scene information is input into the foreground field model to acquire a foreground point cloud; the initial scene information is input into the background field model to acquire a background point cloud; and the foreground point cloud and the background point cloud are stitched to acquire the target scene information.

Specifically, the background field model is represented as a set of points in the world coordinate system. Each point is assigned with a 3D Gaussian to softly represent the continuous scene geometry and color. The Gaussian parameters consist of a covariance matrix Σ_{b} and a position vector μ_{b}∈ [symbol] ³, which denotes the mean value. To avoid invalid value during optimization, each covariance matrix is further reduced to a scaling matrix S_{b} and a rotation matrix R_{b}, where S_{b} is characterized by its diagonal elements and R_{b} is converted into a unit quaternion. The covariance matrix Σ_{b} can be recovered from S_{b} and R_{b} as:

$${\sum }_{b} = {R}_{b} {S}_{b} {S}_{b}^{T} {R}_{b}^{T} . \qquad ( 1 )$$

Apart from the position and covariance matrix, each Gaussian is also assigned with an opacity value α_{b}∈ [symbol] and a set of spherical harmonics coefficients

$${z}_{b} = {( {z}_{m , l} )}_{l : 0 \leq ℓ \leq {ℓ}_{max}}^{m : - ℓ \leq m \leq ℓ}$$

to represent scene geometry and appearance. To obtain the view dependent color, the spherical harmonics coefficients are further multiplied by the spherical harmonics basis functions projected from the view direction. To represent 3D semantic information, each point is added with a semantic logit β_{b}∈ [symbol] ^{M}, where M is the number of semantic classes.

Regarding the foreground field model, consider a scene containing N moving foreground object vehicles. Each object is represented with a set of optimizable tracked vehicle poses and a point cloud, where each point is assigned a 3D Gaussian, semantic logits, and a dynamic appearance model.

The Gaussian properties of both the object and the background are similar, sharing the same meaning for opacity αₒ and scale matrix Sₒ. However, their position, rotation, and appearance models differ from those of the background field model. The position μₒ and rotation Rₒ are defined in the object local coordinate system. To transform them into the world coordinate system (the background's coordinate system), we introduce the definition of tracked poses for objects. Specifically, the tracked poses of vehicles are defined as a set of rotation matrices

$${\{ {R}_{t} \}}_{t = 1}^{{N}_{t}}$$

and translation vectors

$${\{ {T}_{t} \}}_{t = 1}^{{N}_{t}} ,$$

where Nₜ represents the number of frames. The transformation can be defined as:

$${μ}_{w} = {R}_{t} {μ}_{o} + {T}_{t} , \qquad ( 2 )$$

$${R}_{w} = {R}_{t} {R}_{o} ,$$

where μ_{w} and R_{w} are the position and rotation of the corresponding object Gaussian in the world coordinate system, respectively. After transformation, the object's covariance matrix Σ_{w} can be obtained by Eq. 1 with R_{w} and Sₒ. Note that we also found the tracked vehicle poses from the off-the-shelf tracker to be noisy. To address this issue, we treat the tracked vehicle poses as learnable parameters.

Simply representing object appearance with the spherical harmonics coefficients is insufficient for modeling the appearance of moving vehicles, because the appearance of a moving vehicle is influenced by its position in the global scene. One straightforward solution is to use separate spherical harmonics to represent the object for each timestep. However, this representation will significantly increase the storage cost. Instead, we introduce the 4D spherical harmonics model by replacing each SH coefficient z_{m,l} with a set of fourier transform coefficients f∈ [symbol] ^{k}, where k is the number of fourier coefficient. Given timestep t, z_{m,l} is recovered by performing real-valued Inverse Discrete Fourier Transform:

$${z}_{m , l} = {\sum }_{i = 0}^{k - 1} {f}_{i} cos ( \frac{i π}{{N}_{t}} t ) . \qquad ( 3 )$$

With the proposed model, we encode time information into appearance without high storage cost.

The semantic representation of the foreground field model is different from that of background. The main difference is that the semantic of the foreground field model is a learnable one-dimensional scalar βₒ which represents the vehicle semantic class from the tracker instead of a M-dimensional vector β_{b}.

We use aggregated LiDAR point cloud captured by ego vehicle as initialization. The colors of LiDAR point cloud are obtained by projecting to the corresponding image plane and querying the pixel value.

To initialize the foreground field model, we first collect aggregated points inside the 3D bounding boxes and transform them into the local coordinate system. For object with less than 2K LiDAR points, we instead randomly sample 8K points inside the 3D bounding box as initialization. For the background field model, we perform voxel downsampling for the remaining point cloud and filter out the points which are invisible to the training cameras. We incorporate SfM point cloud to compensate for the limited coverage of LiDAR over large areas.

It should be noted that there are multiple foreground field models. Foreground objects with one category correspond to one foreground field model.

It should be noted that there is one background field model.

In the embodiment of the present disclosure, the initial scene information can be directly input into the foreground field model and the background field model, respectively, to acquire the foreground point cloud and the background point cloud, respectively.

In the embodiment of the present disclosure, the foreground point cloud includes position information of the foreground object, and the background point cloud includes position information of the background object.

In an embodiment of the present disclosure, the process of the apparatus for information processing stitching the foreground point cloud and the background point cloud to acquire the target scene information includes that: an occlusion relationship between objects is determined according to position information of a foreground object in the foreground point cloud and position information of a background object in the background point cloud; and the foreground point cloud and the background point cloud are stitched according to the occlusion relationship to acquire the target scene information.

It should be noted that the objects include the foreground object and the background object.

It should be noted that the number of foreground objects may be one or more, and the specific number of foreground objects may be determined according to the actual situation, and the embodiment of the present disclosure is not limited thereto. The number of background objects may be one or more, and the specific number of background objects may be determined according to the actual situation, and the embodiment of the present disclosure is not limited thereto.

In the embodiment of the present disclosure, the foreground field model may use the position and size information of a pedestrian, an automobile, a bicycle (foreground objects) in the labeled file (i.e., the initial scene information) and the reconstructed foreground point cloud. The background field model may use the position and size information of the background object in the labeled file (i.e., the initial scene information) and the reconstructed background point cloud. The foreground point cloud and the background point cloud may be used to determine the distance, thereby acquiring the occlusion relationship.

In an embodiment of the present disclosure, the process of the apparatus for information processing acquiring the initial scene information of the to-be-tested road section further includes that: a pose of the target vehicle on the to-be-tested road section is acquired; and the process of the apparatus for information processing inputting the initial scene information into the background field model to acquire the background point cloud includes that: the pose and the initial scene information are input into the background field model to acquire the background point cloud.

It should be noted that the pose may be the position and direction of the target vehicle.

In the embodiment of the present disclosure, scenes of the target vehicle in different directions can be rendered according to the positions and directions of the target vehicle, for example, there is a traffic light 5 meters in front of the target vehicle, there is a tree 1 meter in a front-right direction of the target vehicle, and there is a shopping mall 20 meters in a front-left direction of the target vehicle.

In the embodiment of the present disclosure, before generating the target scene information of the target vehicle traveling on the to-be-tested road section according to the initial scene information by using the world model, the apparatus for information processing further acquires initial sample scene information, labels the initial sample scene information to acquire labeled initial sample scene information, and trains an initial world model by using the labeled initial sample scene information to acquire the world model.

It should be noted that the initial sample scene information includes a sample scene image or a sample point cloud of a sample scene.

In the embodiment of the present disclosure, the process of labeling the initial sample scene information may be determined according to the actual situation, and the embodiment of the present disclosure is not limited thereto.

Exemplarily, the initial sample scene information may be labeled by a point cloud detection model, a point cloud semantic segmentation model, or the like, to acquire the labeled initial sample scene information.

In the embodiment of the present disclosure, the labeling of the initial sample scene information is to label an object category (for example, a pedestrian, a bicycle, an automobile, or the like) to which each point in the initial sample scene information belongs.

In the embodiment of the present disclosure, acquiring the initial sample scene information further includes that: a pose of the sample vehicle is acquired; and the initial background field model is trained by using the pose and labeled sample background point cloud to acquire the background field model.

It can be understood that the apparatus for information processing realizes the process of labeling the initial sample scene information by combining the outputs of multiple point cloud related models (such as the point cloud detection model and the point cloud semantic segmentation model) as prior information of data preprocessing, and improves the accuracy of data preprocessing labels, thereby improving the accuracy of extraction of foreground and background training point cloud, and improving the model effect.

In the embodiment of the present disclosure, the apparatus for information processing may acquire the initial sample scene information from a database, may acquire the initial sample scene information from other devices, or may acquire the initial sample scene information by other manners. The specific manner of the apparatus for information processing acquiring the initial sample scene information may be determined according to the actual situation, and the embodiment of the present disclosure is not limited thereto.

For example, the initial sample scene information of the target vehicle on the to-be-tested road section may be acquired; the initial sample scene information of other vehicles on the to-be-tested road section may be acquired; the initial sample scene information of the target vehicle on other test road sections or the initial sample scene information of other vehicles on other road sections may be acquired. The initial sample scene information of the target vehicle on the to-be-tested road section, the initial sample scene information of other vehicles on the to-be-tested road section, the initial sample scene information of the target vehicle on other test road sections, and the initial sample scene information of other vehicles on other road sections may be acquired, which may be specifically determined according to the actual situation, and the embodiment of the present disclosure is not limited thereto.

It can be understood that the richness of data is increased by acquiring the initial sample scene information of the target vehicle on the to-be-tested road section, the initial sample scene information of other vehicles on the to-be-tested road section, the initial sample scene information of the target vehicle on other test road sections, and the initial sample scene information of other vehicles on other road sections. For the same scene, data is collected only in one trip, the observation positions and viewing angles are limited, resulting in insufficient data coverage and incomplete scene information for the model. By collecting the scene data in multiple trips, the observation positions and viewing angles between multiple trips are different, which can provide more comprehensive information about the scene and improve the accuracy of the trained world model.

In the embodiment of the present disclosure, the process of the apparatus for information processing training the initial world model by using the labeled initial sample scene information to acquire the world model includes that: in a case that the labeled initial sample scene information is a labeled sample point cloud, a noise point cloud is eliminated from the labeled initial sample scene information to acquire point clouds after elimination; the point clouds after elimination are classified to acquire a labeled sample foreground point cloud and a labeled sample background point cloud; an initial foreground field model is trained by using the labeled sample foreground point cloud to acquire a foreground field model; and an initial background field model is trained by using the labeled sample background point cloud to acquire a background field model.

It should be noted that the world model includes the foreground field model and the background field model. That is, after acquiring the foreground field model and the background field model, the foreground field model and the background field model can be used as the world model, thus acquiring the world model.

In the embodiment of the present disclosure, the initial world model includes an initial foreground field model and an initial background field model.

In the embodiment of the present disclosure, the noise point cloud and the point cloud of uncertain type caused by inaccurate labeling may be eliminated from the labeled initial sample scene information to acquire the point clouds after elimination.

In the embodiment of the present disclosure, the point clouds after elimination may be classified according to the labeling result in the labeled initial sample scene information, to acquire the labeled sample foreground point cloud and the labeled sample background point cloud.

In the embodiment of the present disclosure, the internal structure of the initial foreground field model is trained by using the labeled sample foreground point cloud, and various parameters in the internal structure of the initial foreground field model are optimized through model training, so as to acquire the foreground field model. The internal structure of the initial background field model is trained by using the labeled sample background point cloud, and various parameters in the internal structure of the initial background field model are optimized through model training, so as to acquire the background field model.

For example, the initial background field model is illustrated in FIG. 2. The sample pose of the sample object and the labeled sample foreground image information are acquired, and the sample pose and the labeled sample foreground image information are processed through Hash Encoding, SdfNet, Spherical Encoding, Sdf Value, Geometry Feats, Func (sdf), IntensityNet, Raydrop Net, etc. in the initial background field model, so as to optimize various parameters in the internal structure of the initial background field model, and finally acquire the background field model.

In the embodiment of the present disclosure, the process of the apparatus for information processing training the initial world model by using the labeled initial sample scene information to acquire the world model includes that: in a case that the labeled initial sample scene information is a labeled sample image, the labeled initial sample scene information is split to acquire labeled sample foreground image information and labeled sample background image information; an initial foreground field model is trained by using the labeled sample foreground image information to acquire a foreground field model; an initial background field model is trained by using the labeled sample background image information to acquire a background field model; and the world model is established according to the foreground field model and the background field model.

In the embodiment of the present disclosure, the labeled initial sample scene information may be split according to the labeling result in the labeled initial sample scene information, to acquire the labeled sample foreground image information and the labeled sample background image information. The labeled initial sample scene information may be split by other manners to acquire the labeled sample foreground image information and the labeled sample background image information, and the specific embodiment may be determined according to the actual situation, and the embodiment of the present disclosure is not limited thereto.

In the embodiment of the present disclosure, the internal structure of the initial foreground field model is trained by using the labeled sample foreground image information, and various parameters in the internal structure of the initial foreground field model are optimized through model training, so as to acquire the foreground field model. The internal structure of the initial background field model is trained by using the labeled sample background image information, and various parameters in the internal structure of the initial background field model are optimized through model training, so as to acquire the background field model.

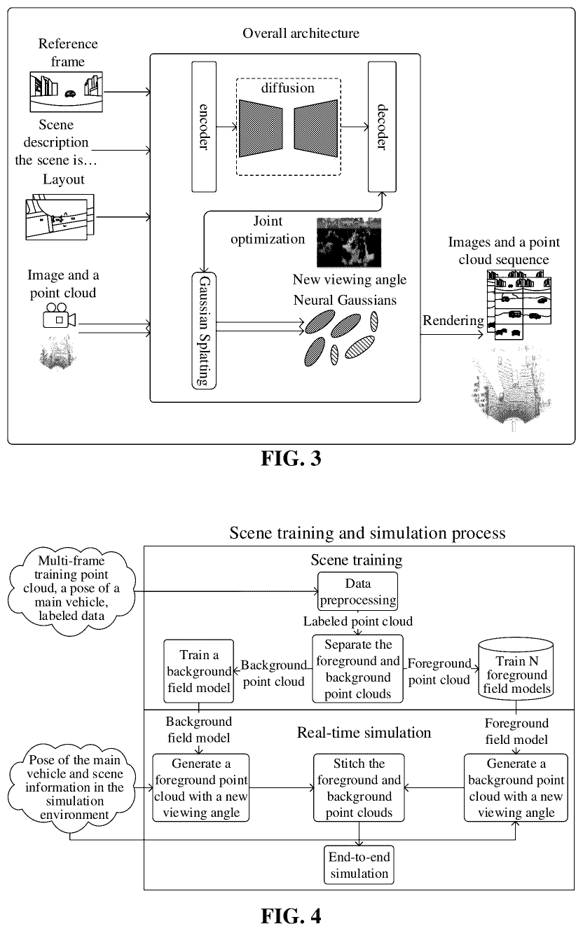

For example, as illustrated in FIG. 3, the initial scene information (including a reference frame, scene description, Layout, an image and a point cloud) of the to-be-tested road section is acquired, and the initial scene information is rendered from a new viewing angle by using the world model. Specifically, by passing through encoder, defusion, encoder and joint optimization, and then through Gaussian Splatting and Neural Gaussians, images and a point cloud sequence are acquired by rendering, that is, the target scene information is acquired.

To render Street Gaussians, we need to aggregate the contribution of each model to render the final image. Street Gaussians can be rendered by contacting all the point clouds and projecting them to 2D image space. Specifically, given a rendered time step t, we first compute spherical harmonics Eq. 3, and transform the object point cloud into the world coordinate system using and Eq. 2 according to tracked vehicle pose (Rₜ, Tₜ). Then we concatenate the background point cloud and the transformed object point clouds to form a new point cloud. To project this point cloud to 2D image space with camera extrinsic W and intrinsic K, we compute the 2D Gaussian for each point in the point cloud:

$${μ}^{′} = K {W}_{μ} , \qquad ( 4 )$$

$${\sum }^{′} = JW \sum {W}^{T} {J}^{T} ,$$

where J is the Jacobian matrix of K. μ′ and Σ′ are the position and covariance matrix in 2D image space, respectively. Point-based α-blending for each pixel is used to compute the color C:

$$C = {\sum }_{i ∈ N} {c}_{i} {α}_{i} {\prod }_{j = 1}^{i - 1} 1 - {α}_{j} \qquad ( 5 )$$

Here αᵢ is the opacity α multiplied by the probability of the 2D Gaussian and cᵢ is the color computed from spherical harmonics z with the view direction. We can also render other signals like depth, opacity and semantic. For instance, the semantic map is rendered by changing color c in Eq. 5 to semantic logits β.

Since 3D Gaussian is defined in Euclidean space, it is inappropriate for them to model distant regions like sky. As a result, we utilize a high resolution cubemap which maps the view direction to sky color C_{sky}. The explicit cubemap representation helps us recover details in sky regions without sacrificing inference speed. The final rendering color is obtained by blending C_{sky} and the color C in Eq. 5.

Regarding the aspect of tracking pose optimization, positions and covariance matrices of the object Gaussians during the above rendering are closely correlated with the tracked pose parameters as shown in Eq. 2. However, bounding boxes produced by the tracker model are generally noisy. Directly using them to optimize our scene representation leads to degradation in rendering quality. As a result, we treat tracked poses as learnable parameters by adding a learnable transformation to each transformation matrix. Specifically, Rₜ and Tₜ in Eq. 2 are replaced by Rₜ′ and Tₜ′ which are defined as:

$${R}_{t}^{′} = {R}_{t} Δ {R}_{t} , \qquad ( 6 )$$

$${T}_{t}^{′} = {T}_{t} + Δ {T}_{t} ,$$

where ΔRₜ and ΔTₜ are the learnable transformation. We represent ΔTₜ as a 3D vector and ΔRᵢ as a rotation matrix converted from yaw offset angle Δθₜ. Gradients of these transformations can be directly obtained without any implicit function or intermediate processes, which do not require any extra computation during back-propagation.

We jointly optimize our scene representation, sky cubemap and tracked poses using the following loss function:

$$L = {L}_{color} + {λ}_{1} {L}_{depth} + {λ}_{2} {L}_{sky} + {λ}_{3} {L}_{s e m} + {λ}_{4} {L}_{reg} . \qquad ( 7 )$$

L_{color} is the reconstruction loss between rendered and observed images. L_{depth} is a L1 loss between rendered depth and the depth generated by projecting sparse LiDAR points onto the camera plane. L_{sky} is a binary cross entropy loss for sky supervision. Lₛₑₘ is an optional per-pixel softmax-cross-entropy loss between rendered semantic logits and input 2D semantic segmentation predictions, and L_{reg} is an regularization term used to remove floaters and enhance decomposition effects.

Exemplarily, as illustrated in FIG. 4, the initial sample scene information (a multi-frame training point cloud, a pose of a main vehicle, labeled data) is acquired. The initial sample scene information is labeled through data preprocessing, to acquire the labeled initial sample scene information (a labeled point cloud). In a case that the labeled initial sample scene information is a labeled sample point cloud, a noise point cloud is eliminated from the labeled initial sample scene information to acquire point clouds after elimination. The point clouds after elimination are classified to acquire a labeled sample foreground point cloud and a labeled sample background point cloud (the foreground and background point cloud is separated). An initial foreground field model is trained by using the labeled sample foreground point cloud to acquire a foreground field model (N foreground field models are trained to acquire a foreground field model). An initial background field model is trained by using the labeled sample background point cloud to acquire a background field model (a background field model is acquired by training a background field model). The initial scene information of the to-be-tested road section (the pose of the main vehicle and scene information in the simulation environment) is acquired. The initial scene information is input into the foreground field model to acquire a foreground point cloud (a foreground point cloud with a new viewing angle is generated). The initial scene information is input into the background field model to acquire a background point cloud (a background point cloud with a new viewing angle is generated). The foreground point cloud and the background point cloud are stitched (the foreground and background point clouds are stitched) to acquire the target scene information, and an end-to-end simulation process is realized by using the target scene information.

It can be understood that the target scene information of the target vehicle traveling on the to-be-tested road section is generated by acquiring the initial scene information of the to-be-tested road section and using the world model to render the initial scene information, and the sensor data rendered by the world model is close to the real data, that is, the accuracy of generating the target scene information is improved.

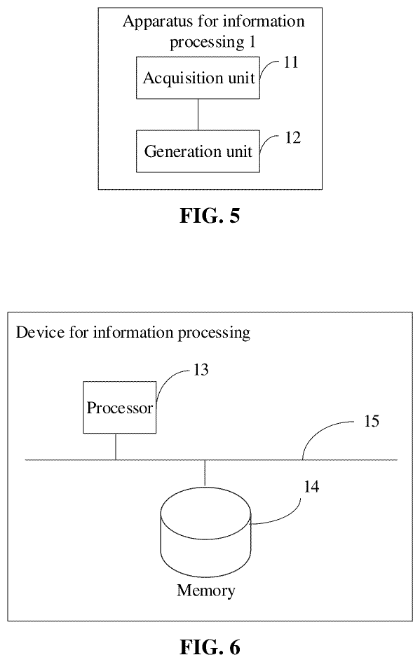

An embodiment of the present disclosure provides, based on the same inventive concept as the method for information processing described above, an apparatus 1 for information processing corresponding to a method for information processing applied to an apparatus for information processing. FIG. 5 is a schematic diagram of a composition structure of an apparatus for information processing according to an embodiment of the present disclosure, and the apparatus for information processing 1 may include an acquisition unit 11 and a generation unit 12.

The acquisition unit 11 is configured to acquire initial scene information of a to-be-tested road section, where the initial scene information includes a scene image or a point cloud of a scene.

The generation unit 12 is configured to generate target scene information of a target vehicle traveling on the to-be-tested road section according to the initial scene information by using a world model.

In some embodiments of the present disclosure, the apparatus further includes an input unit.

The input unit is configured to, in a case that the initial scene information is the scene image, input the initial scene information into the world model to acquire the target scene information.

In some embodiments of the present disclosure, the apparatus further includes a modeling unit, a modifying unit, and a determining unit.

The modeling unit is configured to perform three-dimensional modeling on the initial scene information by using the world model, to acquire foreground image information and background image information.

The modifying unit is configured to modify the foreground image information to acquire modified foreground image information.

The determining unit is configured to determine the target scene information according to the background image information and the modified foreground image information by using the world model.

In some embodiments of the present disclosure, the apparatus further includes a stitching unit.

The input unit is configured to: in a case that the initial scene information is the point cloud, input the initial scene information into the foreground field model to acquire a foreground point cloud; and input the initial scene information into the background field model to acquire a background point cloud.

The stitching unit is configured to stitch the foreground point cloud and the background point cloud to acquire the target scene information.

In some embodiments of the present disclosure, the determining unit is configured to determine an occlusion relationship between objects according to position information of a foreground object in the foreground point cloud and position information of a background object in the background point cloud, where the objects include the foreground object and the background object.

The stitching unit is configured to stitch the foreground point cloud and the background point cloud according to the occlusion relationship to acquire the target scene information.

In some embodiments of the present disclosure, the acquisition unit 11 is configured to acquire a pose of the target vehicle on the to-be-tested road section.

Accordingly, the input unit is configured to input the pose and the initial scene information into the background field model to acquire the background point cloud.

In some embodiments of the present disclosure, the apparatus further includes an adding unit.

The acquisition unit 11 is configured to acquire first scene information of the target vehicle.

The adding unit is configured to add obstacle information to the first scene information to acquire the initial scene information.

In some embodiments of the present disclosure, the first scene information is information acquired by the target vehicle performing detection.

Alternatively, the first scene information is information generated by using a scene generation algorithm.

In some embodiments of the present disclosure, the apparatus further includes a labeling unit and a training unit.

The acquisition unit 11 is configured to acquire initial sample scene information, where the initial sample scene information includes a sample scene image or a sample point cloud of a sample scene.

The labeling unit is configured to label the initial sample scene information to acquire labeled initial sample scene information.

The training unit is configured to train an initial world model by using the labeled initial sample scene information to acquire the world model.

In some embodiments of the present disclosure, the apparatus further includes an elimination unit and a classification unit.

The elimination unit is configured to, in a case that the labeled initial sample scene information is a labeled sample point cloud, eliminate a noise point cloud from the labeled initial sample scene information to acquire point clouds after elimination.

The classification unit is configured to classify the point clouds after elimination to acquire a labeled sample foreground point cloud and a labeled sample background point cloud.

The training unit is configured to train an initial foreground field model by using the labeled sample foreground point cloud to acquire a foreground field model; and train an initial background field model by using the labeled sample background point cloud to acquire a background field model, where the world model includes the foreground field model and the background field model.

In some embodiments of the present disclosure, the apparatus further includes a splitting unit and an establishment unit.

The splitting unit is configured to, in a case that the labeled initial sample scene information is a labeled sample image, split the labeled initial sample scene information to acquire labeled sample foreground image information and labeled sample background image information.

The training unit is configured to train an initial foreground field model by using the labeled sample foreground image information to acquire a foreground field model; and train an initial background field model by using the labeled sample background image information to acquire a background field model.

The establishment unit is configured to establish the world model according to the foreground field model and the background field model.

Note that, in practical applications, the acquisition unit 11 and the generation unit 12 may be implemented by a processor 13 on a device for information processing, specifically, a Central Processing Unit (CPU), a Microprocessor Unit (MPU), a Digital Signal Processing (DSP), a Field Programmable Gate Array (FPGA), or the like. The above-described data storage may be implemented by a memory 14 on the device for information processing.

An embodiment of the present disclosure also provides a device for information processing, as illustrated in FIG. 6, the device for information processing includes: a processor 13, a memory 14, and a communication bus 15. The memory 14 communicates with the processor 13 through the communication bus 15. The memory 14 stores a program executable by the processor 13, and when the program is executed, the above-described method for information processing is performed by the processor 13.

In practical applications, the above-described memory 14 may be a volatile memory (such as a Random-Access Memory (RAM)), or a non-volatile memory (such as a Read-Only Memory (ROM), a flash memory, a Hard Disk Drive (HDD) or a Solid-State Drive (SSD)), or a combination of the kinds of memories described above, and provides instructions and data to the processor 13.

An embodiment of the present disclosure provides a computer program product. The computer program product includes a computer program or computer-executable instructions stored in a computer-readable storage medium. A processor in the device for information processing reads the computer-executable instructions from the computer-readable storage medium, and executes the computer-executable instructions, so that the apparatus for information processing performs the above-described method for information processing according to the embodiment of the present disclosure.

An embodiment of the present disclosure provides a computer-readable storage medium. The computer-readable storage medium stores computer-executable instructions that, when executed by a processor 13, cause the processor 13 to perform the method for information processing according to the embodiments of the present disclosure, for example, the method for information processing as illustrated in FIG. 1.

In some embodiments, the computer-readable storage medium may be a memory such as a FRAM, a ROM, a PROM, an EPROM, an EEPROM, a flash memory, a magnetic surface memory, an optical disk, or a CD-ROM. It may also be a variety of devices including one or any combination of the above-mentioned memories.

In some embodiments, the computer-executable instructions may take the form of programs, software, software modules, scripts, or code, written in any form of programming language, including compiled or interpreted languages, or declarative or procedural languages, and may be deployed in any form, including being deployed as standalone programs or as modules, components, subroutines, or other units suitable for use in a computing environment.

As an example, computer-executable instructions may, but do not necessarily correspond to files in a file system, they be stored as part of a file holding other programs or data, for example, stored in one or more scripts stored in a Hyper Text Markup Language (HTML) document, stored in a single file dedicated to the program in question, or stored in multiple co-files (e.g., files storing one or more modules, subroutines, or code sections).

It can be understood that the target scene information of the target vehicle traveling on the to-be-tested road section is generated by acquiring the initial scene information of the to-be-tested road section and using the world model to render the initial scene information, and the sensor data rendered by the world model is close to the real data, that is, the accuracy of generating the target scene information is improved.

1. A method for information processing, comprising:
acquiring initial scene information of a to-be-tested road section, wherein the initial scene information comprises a scene image or a point cloud of a scene; and
generating target scene information of a target vehicle traveling on the to-be-tested road section according to the initial scene information by using a world model.

2. The method of claim 1, wherein generating the target scene information of the target vehicle traveling on the to-be-tested road section according to the initial scene information by using the world model comprises:
in a case that the initial scene information is the scene image, inputting the initial scene information into the world model to acquire the target scene information.

3. The method of claim 2, wherein inputting the initial scene information into the world model to acquire the target scene information comprises:
performing three-dimensional modeling on the initial scene information by using the world model, to acquire foreground image information and background image information;
modifying the foreground image information to acquire modified foreground image information; and
determining the target scene information according to the background image information and the modified foreground image information by using the world model.

4. The method of claim 1, wherein the world model comprises a foreground field model and a background field model, and generating the target scene information of the target vehicle traveling on the to-be-tested road section according to the initial scene information by using the world model comprises:
in a case that the initial scene information is the point cloud, inputting the initial scene information into the foreground field model to acquire a foreground point cloud;
inputting the initial scene information into the background field model to acquire a background point cloud; and
stitching the foreground point cloud and the background point cloud to acquire the target scene information.

5. The method of claim 4, wherein stitching the foreground point cloud and the background point cloud to acquire the target scene information comprises:
determining an occlusion relationship between objects according to position information of a foreground object in the foreground point cloud and position information of a background object in the background point cloud, wherein the objects comprise the foreground object and the background object; and
stitching the foreground point cloud and the background point cloud according to the occlusion relationship to acquire the target scene information.

6. The method of claim 4, wherein acquiring the initial scene information of the to-be-tested road section further comprises:
acquiring a pose of the target vehicle on the to-be-tested road section; and
inputting the initial scene information into the background field model to acquire the background point cloud comprises:
inputting the pose and the initial scene information into the background field model to acquire the background point cloud.

7. The method of claim 1, wherein acquiring the initial scene information of the to-be-tested road section comprises:
acquiring first scene information of the target vehicle; and
adding obstacle information to the first scene information to acquire the initial scene information.

8. The method of claim 7, wherein
the first scene information is information acquired by the target vehicle performing detection; or
the first scene information is information generated by using a scene generation algorithm.

9. The method of claim 1, further comprising: before generating the target scene information of the target vehicle traveling on the to-be-tested road section according to the initial scene information by using the world model,
acquiring initial sample scene information, wherein the initial sample scene information comprises a sample scene image or a sample point cloud of a sample scene;
labeling the initial sample scene information to acquire labeled initial sample scene information; and
training an initial world model by using the labeled initial sample scene information to acquire the world model.

10. The method of claim 9, wherein training the initial world model by using the labeled initial sample scene information to acquire the world model comprises:
in a case that the labeled initial sample scene information is a labeled sample point cloud, eliminating a noise point cloud from the labeled initial sample scene information to acquire point clouds after elimination;
classifying the point clouds after elimination to acquire a labeled sample foreground point cloud and a labeled sample background point cloud;
training an initial foreground field model by using the labeled sample foreground point cloud to acquire a foreground field model; and
training an initial background field model by using the labeled sample background point cloud to acquire a background field model, wherein the world model comprises the foreground field model and the background field model.

11. The method of claim 9, wherein training the initial world model by using the labeled initial sample scene information to acquire the world model comprises:
in a case that the labeled initial sample scene information is a labeled sample image, splitting the labeled initial sample scene information to acquire labeled sample foreground image information and labeled sample background image information;
training an initial foreground field model by using the labeled sample foreground image information to acquire a foreground field model;
training an initial background field model by using the labeled sample background image information to acquire a background field model; and
establishing the world model according to the foreground field model and the background field model.

12. A device for information processing, comprising:
a memory, configured to store computer-executable instructions; and
a processor, configured to execute the computer-executable instructions stored in the memory to perform operations of:
acquiring initial scene information of a to-be-tested road section, wherein the initial scene information comprises a scene image or a point cloud of a scene; and
generating target scene information of a target vehicle traveling on the to-be-tested road section according to the initial scene information by using a world model.

13. The device of claim 12, wherein when generating the target scene information of the target vehicle traveling on the to-be-tested road section according to the initial scene information by using the world model, the processor is specifically configured to:
in a case that the initial scene information is the scene image, input the initial scene information into the world model to acquire the target scene information.

14. The device of claim 13, wherein when inputting the initial scene information into the world model to acquire the target scene information, the processor is specifically configured to:
perform three-dimensional modeling on the initial scene information by using the world model, to acquire foreground image information and background image information;
modify the foreground image information to acquire modified foreground image information; and
determine the target scene information according to the background image information and the modified foreground image information by using the world model.

15. The device of claim 12, wherein the world model comprises a foreground field model and a background field model, and when generating the target scene information of the target vehicle traveling on the to-be-tested road section according to the initial scene information by using the world model, the processor is specifically configured to:
in a case that the initial scene information is the point cloud, input the initial scene information into the foreground field model to acquire a foreground point cloud;
input the initial scene information into the background field model to acquire a background point cloud; and
stitch the foreground point cloud and the background point cloud to acquire the target scene information.

16. The device of claim 15, wherein when stitching the foreground point cloud and the background point cloud to acquire the target scene information, the processor is specifically configured to:
determine an occlusion relationship between objects according to position information of a foreground object in the foreground point cloud and position information of a background object in the background point cloud, wherein the objects comprise the foreground object and the background object; and
stitch the foreground point cloud and the background point cloud according to the occlusion relationship to acquire the target scene information.

17. The device of claim 15, wherein when acquiring the initial scene information of the to-be-tested road section, the processor is further configured to:
acquire a pose of the target vehicle on the to-be-tested road section; and
when inputting the initial scene information into the background field model to acquire the background point cloud, the processor is specifically configured to:
input the pose and the initial scene information into the background field model to acquire the background point cloud.

18. The device of claim 12, wherein when acquiring the initial scene information of the to-be-tested road section, the processor is specifically configured to:
acquire first scene information of the target vehicle; and
add obstacle information to the first scene information to acquire the initial scene information.

19. The device of claim 18, wherein
the first scene information is information acquired by the target vehicle performing detection; or
the first scene information is information generated by using a scene generation algorithm.

20. A non-transitory computer-readable storage medium, having stored thereon computer-executable instructions that, when executed by a processor, perform operations of:
acquiring initial scene information of a to-be-tested road section, wherein the initial scene information comprises a scene image or a point cloud of a scene; and
generating target scene information of a target vehicle traveling on the to-be-tested road section according to the initial scene information by using a world model.
